(19) United States
(12) Patent Application Publication
(10) Pub. No.: US 2005/0187108 A1
(43) Pub. Date: Aug. 25, 2005

(54) Certain plant growth regulators (PGRs) as safener to Glyphosate for application to Glyphosate-tolerant crops

(76) Inventors: Denny Ng, Arcadia, CA (US); Der-I Wang, Arcadia, CA (US)

Correspondence Address: LAW OFFICES OF J.F. LEE, 17800 CASTLETON STREET, SUITE 383, CITY OF INDUSTRY, CA, 91748, US

(21) Appl. No.: 10/785,906

(22) Filed: Feb. 23, 2004

(51) Int. Cl. A01N 25/26; A01N 57/18

(52) U.S. Cl. 504/106

(57) ABSTRACT

When the Glyphosate-tolerant crops, known as Round-Up Ready crops, are sprayed with Glyphosate in the field, the crops may exhibit some extent of phototoxicity, although the weeds are killed, as intended. Use of safener additive in present invention as plant growth regulator (PGR), along with Glyphosate, will result in reduced phototoxicity to the crops and thus better crops growth, while the herbicidal activities of Glyphosate are not affected.

### FIELD AND BACKGROUND OF THE INVENTION

Glyphosate, a chemical compound developed in the 1980s, has been used as an active ingredient of agricultural herbicides, especially in controlling major annual and perennial grasses and broad-leafed weeds. When applied to plants, Glyphosate inhibits the plant's EPSPS (5-enolypryuvylshikimate-3-phosphate synthase) enzyme.

The chemical composition and formula of Glyphosate is C₆H₉Na₃N₂O₁₀P₂. It's molecular weight is 422.09. The production of Glyphosate and its mechanism of inhibiting plant growth need not be discussed or disclosed and are not part of the claimed invention in present application.

Some crops, such as cotton, corns, soybeans and other “Glyphosate-tolerant” GMO crops, contain artificially modified EPSPS genes that make the crops tolerant to Glyphosate, at least as claimed by providers of such genetically modified crops. The term “Round-Up Ready” is widely used to describe these genetically modified crops that are claimed to be tolerant to Glyphosate, since the active ingredient in the Round-Up herbicide is Glyphosate.

Field tests on use of Glyphosate, however, showed substantial adverse effect to the growth of Round-Up Ready crops. This adverse effect is referred to as the Glyphosate's phytotoxicity in present application.

Present invention discloses the use of three PGR safener additives that can be mixed into Glyphosate solution to reduce the phytotoxicity, so that the weeds' growth is inhibited, while growth of the desired crops is not.

### OBJECTS AND SUMMARY OF THE INVENTION

Present invention introduces PGR safener additives for improving growth of Round-Up Ready crops, when Glyphosate, or Glyphosate-equivalent product, is applied to such crops, without reducing the growth-inhibiting capacity of Glyphosate.

### DETAILED DESCRIPTION OF THE PREFERRED EMBODIMENT

Dilute Cytokinin (Kinetin 0.15%-0.50%) in water at concentration of 1:1000 by volume. This is the Cytokinin Safener.

Dilute 3-Indolebutyric Acid (0.85% IBA) in water at concentration of 1:1000 by volume. This is the IBA Safener.

Dilute 1-Naphthaleneacetic Acid (0.20% NAA) in water at concentration of 1:1000 by volume. This is the NAA Safener.

Prepare Glyphosate solution at the concentration as instructed by the manufacturer. The Glyphosate solution also refers to any solution made from Glyphosate-equivalent product.

Dilute Cytokinin (Kinetin) Safener to Glyphosate solution at concentration of 1:1 by volume. This is the Cytokinin Mix.

Dilute Cytokinin (Kinetin) Safener and IBA Safener to Glyphosate solution at concentration of 0.5:0.5:1 by volume. This is the Cytokinin-IBA Mix.

Dilute Cytokinin (Kinetin) Safener, IBA Safener and NAA Safener to Glyphosate solution at concentration of 0.33:0.33:0.34:1 by volume. This is the Combo Mix.

When seedlings of Glyphosate-tolerant crops, such as maize and soybean, are about 4 weeks old, spray the Glyphosate solution to the crops in the manners described by the instructions of Glyphosate solution will cause some crop phototoxicity.

The Glyphosate-tolerant crops will show better growth when Glyphosate is applied to the crops along with the 3 Mixes identified above, than when the Glyphosate-tolerant crops are just sprayed with Glyphosate solution alone.

1. (canceled)

2. (canceled)

3. (canceled)

4. Composition of plant growth regulators (PGRs) for application to Glyphosate-tolerant crops, from the mixture by volume in the ratio of 1:1 of two ingredients, consisting essentially of:
a. Glyphosate solution prepared in accordance with manufacturer's instruction; and
b. Cytokinin Safener obtained by diluting Cytokinin (Kinetin, 0.15%-0.50%) in water at concentration of 1:1000 by volume.

5. Composition of plant growth regulators (PGRs) for application to Glyphosate-tolerant crops, from the mixture by volume in the ratio of 1:0.5:0.5 of three ingredients, consisting essentially of:
a Glyphosate solution prepared in accordance with manufacturer's instruction;
b. Cytokinin Safener obtained by diluting Cytokinin (Kinetin, 0.15%-0.50%) in water at concentration of 1:1000 by volume; and,
c. IBA Safener obtained by diluting 3-Indolebutyric Acid (0.85% IBA) in water at concentration of 1:1000 by volume.

6. Composition of plant growth regulators (PGRs) for application to Glyphosate-tolerant crops, from the mixture by volume in the ratio of 1:0.33:0.33:0.34 of four ingredients, consisting essentially of:
a. Glyphosate solution prepared in accordance with manufacturer's instruction;
b. Cytokinin Safener obtained by diluting Cytokinin (Kinetin, 0.15%-0.50%) in water at concentration of 1:1000 by volume;
c. IBA Safener obtained by diluting 3-Indolebutyric Acid (0.85% IBA) in water at concentration of 1:1000 by volume; and,
d. NAA Safener obtained by diluting 1-Naphthaleneacetic Acid (0.20% NAA) in water at concentration of 1:1000 by volume.
